(19) United States
(12) Patent Application Publication
(10) Pub. No.: US 2014/0214947 A1
(43) Pub. Date: Jul. 31, 2014

(54) PRESENTING VISUAL REPRESENTATIONS OF SOCIAL NETWORK INFORMATION

(71) Applicant: Linkedln Corporation, Mountain View, CA (US)

(72) Inventors: Vinodh Jayaram, Fremont, CA (US); Nipun Dave, Mountain View, CA (US); Avery Randolph Moon, Redwood Shores, CA (US)

(73) Assignee: Linkedln Corporation, Mountain View, CA (US)

(21) Appl. No.: 13/859,374

(22) Filed: Apr. 9, 2013

Related U.S. Application Data
(60) Provisional application No. 61/758,977, filed on Jan. 31, 2013.

(51) Int. Cl. H04L 29/08

(52) U.S. Cl. CPC H04L 67/306
USPC 709/204

(57) ABSTRACT

Systems and methods for generating and presenting visual representations associated with profiles of members of social networks are described. In some example embodiments, the systems and methods access member profile information associated with a member of a social network render a visual representation of the accessed member profile information that includes a first visual representation layer associated with a first category of the member profile information and a second visual representation layer associated with a second category of the member profile information, and presents via a user interface the rendered visual representation of the accessed member profile information.

### CROSS REFERENCE TO RELATED APPLICATIONS

This application claims priority to U.S. Provisional Patent Application No. 61/758,977, filed on Jan. 31, 2013, entitled PRESENTING VISUAL REPRESENTATIONS OF SOCIAL NETWORK INFORMATION, which is hereby incorporated by reference in its entirety.

### TECHNICAL FIELD

The present disclosure generally relates to information retrieval and display. More specifically, the present disclosure relates to methods, systems and computer program products for presenting visual representations of social network information.

### BACKGROUND

A social network, such as LinkedIn, Facebook, Google+, Twitter, and so on, may be an online platform or service that provides an interactive environment for people having shared interests, activities, backgrounds, or real-life connections. Typically web-based, a social network facilitates interactions between members, such as by providing messaging services for conversations, profile pages and blogs for information display, timelines for collecting and presenting media, and so on.

### DESCRIPTION OF THE DRAWINGS

Some embodiments of the technology are illustrated by way of example and not limitation in the figures of the accompanying drawings.

FIG. 1 is a block diagram illustrating an example of a network environment including a server operating a visual representation engine, consistent with some embodiments.

FIG. 2 is a display diagram illustrating an example user interface that depicts a visual representation of member profile information, consistent with some embodiments.

FIG. 3 is a block diagram illustrating modules of the visual representation engine, consistent with some embodiments.

FIG. 4 is a display diagram illustrating an example user interface that depicts a visual representation layer of a category of member profile information, consistent with some embodiments.

FIG. 5 is a flow diagram illustrating an example method for presenting a visual representation of social network information, consistent with some embodiments.

FIG. 6 is a flow diagram illustrating an example method 600 for presenting multiple visual representations of social network information, consistent with some embodiments.

FIG. 7 is a display diagram illustrating an example user interface depicting a presentation of multiple visual representations of social network information, consistent with some embodiments.

FIG. 8 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for presenting visual representations of social network information.

In some example embodiments, a visual representation engine accesses information from a social network, such as profile information for a member of the social network, renders a visual presentation of the information, and displays the visual representation via a user interface associated with the social network.

In some example embodiments, the rendered visual representation includes multiple layers associated with categories of information stored by the social network and associated with the member of the social network. For example a rendered visual representation of profile information associated with a member of a professional social network may include a layer associated with work experience information, a layer associated with education experience information, and so on.

In the following description, for purposes of explanation, numerous specific details are set forth in order to provide a thorough understanding of the various aspects of different embodiments of the present technology. It will be evident, however, to one skilled in the art, that the present technology may be practiced without all of the specific details.

Other advantages and aspects of the inventive subject matter will be readily apparent from the description of the figures that follows.

### Example Computing Environment

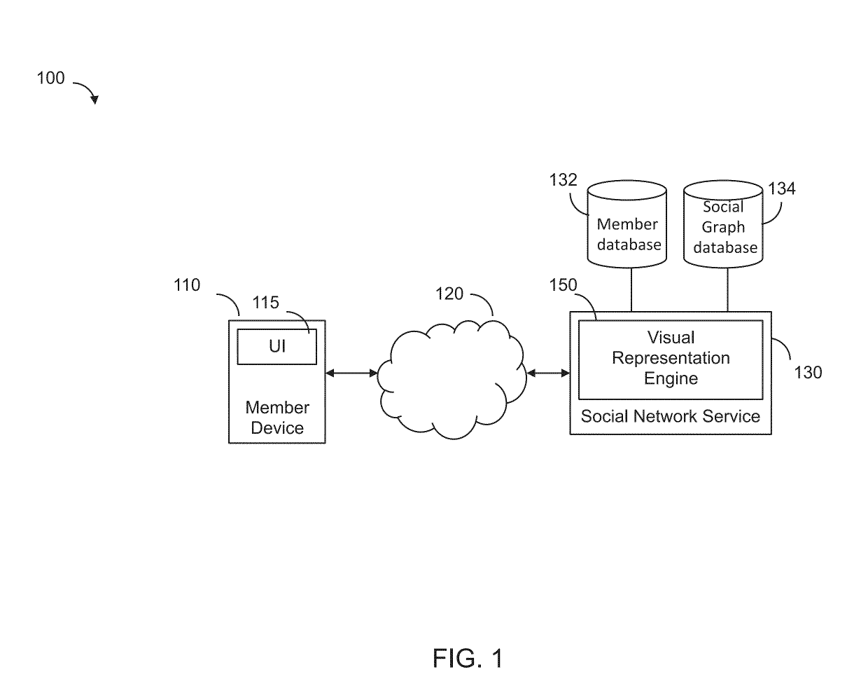

FIG. 1 is a block diagram illustrating an example of a network environment 100 including a server operating a search assist system, consistent with some embodiments.

The network environment 100 includes a user device 110 that includes a browser 115 or other application configured to access a social network service 130 that supports a social network over a network 120. The user device 110 may be any suitable computing device, such as a smart phone, a tablet, a laptop, gaming device, and/or any mobile device or computing device associated with a user, such as a member of the social network, that is capable of interacting with the social network service 130 and presenting, via a user interface, visual representations of information from the social network.

One or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

The social network service 130 may include or access databases that include various categories of data or information, such as a member database 132 that contains member information (e.g., member profile information, member activity information, and so on), a social graph database 134 that contains information associated with connections between members, relationships between members, shared attributes between members, and so on. Additionally, the social network service 130 may include or access other databases that include various other types of information, such as information associated with information posts published within the social network, information associated with media stored by the social network, company or entity information (e.g., company profile information), job listing or other listing information, (e.g., job listings, event listings, activity listings, and so on), and so on.

A social network service 130 is a useful location in which to store, search for, retrieve, and/or obtain various types of information. Often, a social network or other similar site, such as LinkedIn, Facebook, Google+, Twitter, and so on, stores various types of information associated with members of the site, activities performed within the site, and so on. For example, a friend-based social network may store interest information for members (e.g., information about things the members interact with, or “like”), whereas a professional social network may store accomplishment or experience information for members (e.g., educational or work experience information) as well as company profile information, industry information, and so on. Additionally, a social network may store information associated with a member's social graph, such as information identifying other members within the member's social graph, among other things.

In some example embodiments, the social network service 130 includes a visual representation engine 150 that generates, creates, renders, updates, presents, and/or displays visual representations of information associated with the social network, such as member profile information. For example, the visual representation engine 150 may include components or modules that generate and/or render a visual timeline of a member's information.

### Presenting Visual Representations of Social Network Information

In some example embodiments, a presented visual representation of social network information may include various graphical elements that display information associated with a member of the social network in order to present a visual narrative of the member's social and/or professional life, among other things.

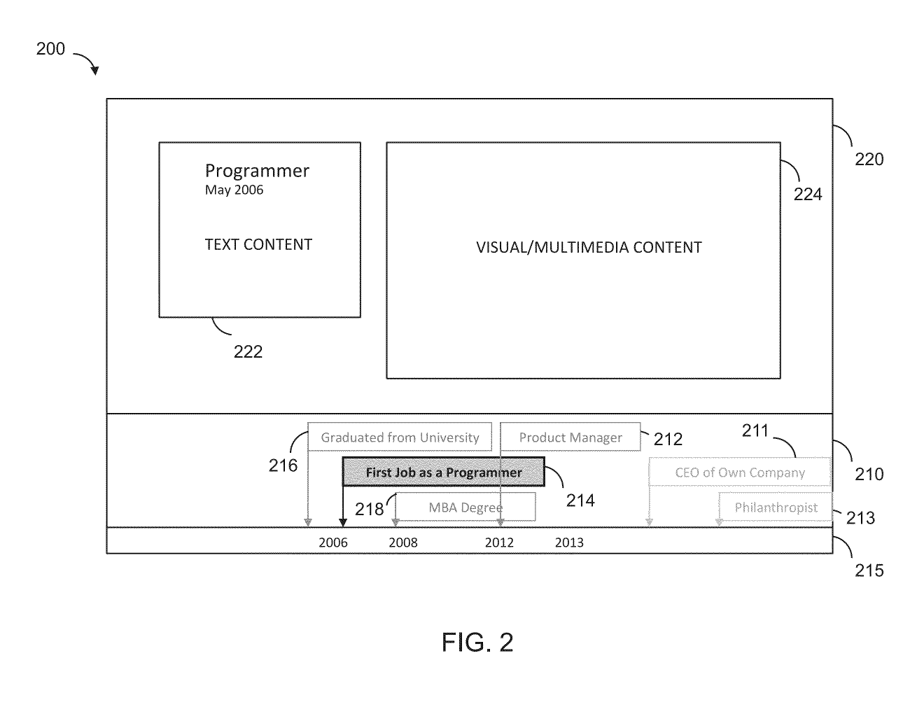

FIG. 2 is a display diagram illustrating an example user interface 200 that depicts a visual representation of member profile information, consistent with some embodiments. The visual representation may include a visual timeline 210 that displays, in chronological order, graphical elements that represent certain member profile information along with time periods 215 associated with the graphical elements. For example, graphical element 212 represents a work experience associated with a job as a “Product Manager” in 2012, while graphical element 214 represents a work experience associated with a “first job as a programmer” in 2006. The visual timeline 210 also includes other graphical elements associated with different categories or types of member profile information, such as graphical element 216, which represents an education experience (“graduated from University”), and graphical element 218, which also represents an education experience (“MBA Degree”), and graphical elements 211, 213 associated with aspirations or other future/intended experiences of a member. Thus, the visual representation 200 may present the graphical elements 211-218 of the visual timeline 210 is such a manner that the elements collectively present a narrative or story about the member of the social network, among other things.

The visual representation 200 may also include visual detail windows 220 that present graphical elements representing details or other complementary information for the experiences depicted by the graphical elements displayed within the visual timeline 210. For example, the visual representation 200 may present within detail window 220, for the “Product Manager” work experience 214 that is highlighted in the Figure, text-based content 222 that provides details about the work experience (title of job, name of company, date range of employment, achievements, and so on). Similarly, visual representation 200 may present within detail window 220 visual-based content 224 that presents images, video clips, pictures, and so on, which are associated with the work experience 214.

Of course, the visual representation 200 may include other windows, graphical elements and/or types of information not shown in the Figure that present a visual history, narrative, or story of a member of a social network using information provided by the social network and/or the member.

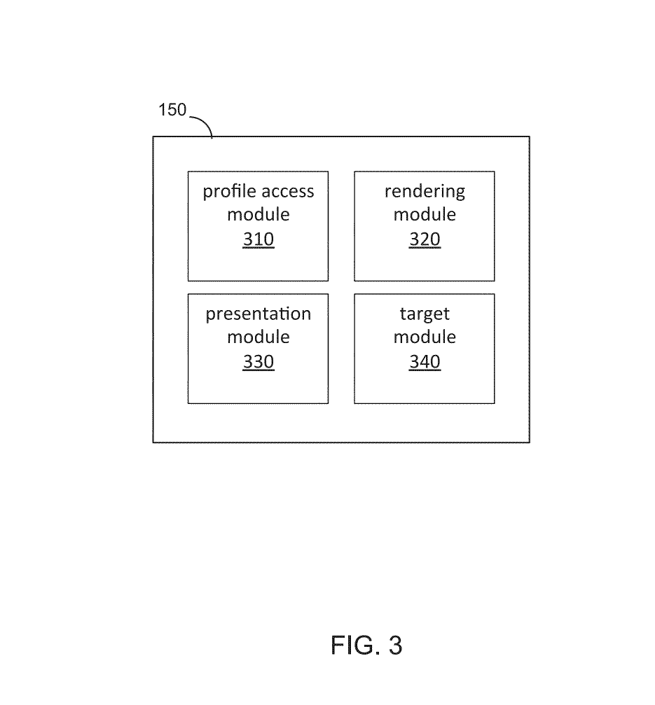

As described herein, in some example embodiments, the visual representation engine 150 renders and/or presents visual representations of social network information, among other things. FIG. 3 is a block diagram illustrating modules of the visual representation engine 150, consistent with some embodiments. As illustrated in FIG. 3, the visual representation engine 150 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

Referring to FIG. 3, the visual representation engine 150 may include a profile access module 310, a rendering module 320, a presentation module 330, and a target module 340, among other modules not shown in the Figure.

In some examples embodiments, the profile access module 310 is configured and/or programmed to access member profile information associated with a member of a social network. For example the profile access module 310 may access, receive, and/or retrieve information contained in member database 132, social graph database 134, or other databases of or accessible by the social network service 130.

Types of information the profile access module 310 may access and/or receive include:

Member profile information, such as information contained in the member database 132, that is associated with a member's educational background or experiences (e.g., school information, degree information, grade information, exam information, activity information, organization information, and so on), work or professional history or experiences (e.g., company information, job title information, job skills information, job responsibility information, length of employment information, resume or CV information, and so on), member biographical information (e.g., residence information, citizenship information, language information, activity and interest information, and so on), and so on; and/or

Social graph information, such as profile information associated with friends, connections, group affiliations, references, relationships and so on, between a member and other members; and so on.

In some example embodiments, the rendering module 320 is configured and/or programmed to render a visual representation of the accessed member profile information. In some example embodiments, the rendering module 320 may automatically render the visual representation of the member profile information. In some example embodiments, the rendering module 320 may render user-selectable portions of member profile information.

The rendering module 320 may render a visual representation that includes a first visual representation layer associated with a first category of member profile information and a second visual representation layer associated with a second category of the member profile information.

That is, the rendering module 320 may render a visual representation that includes one or more graphical elements from one visual representation layer one and one or more graphical elements from another visual representation layer. Each of the visual representation layers may provide a specific narrative via graphical elements that represent information from one category of information (e.g., work, education, life, and so on) provided by the social network service 130 and associated with a member of the social network.

For example, the rendering module 320 may render a visual representation that includes a visual representation layer for a category associated with work experience of the member and a visual representation layer for a category associated with education experience of the member.

In some example embodiments, the presentation module 330 is configured and/or programmed to present via a user interface the rendered visual representation of the accessed member profile information.

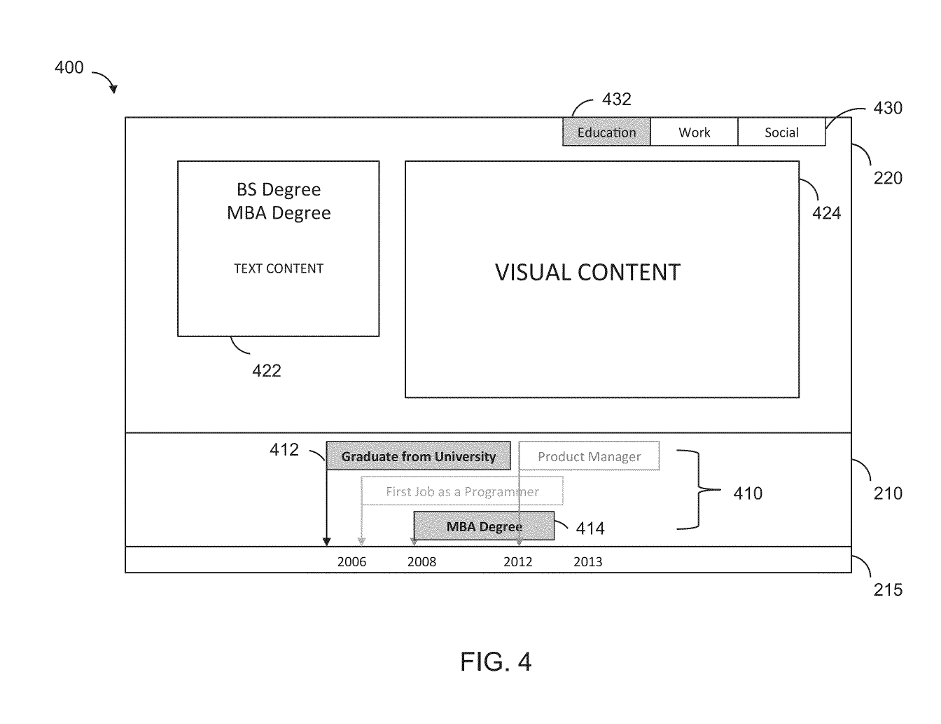

For example, FIG. 4 is a display diagram illustrating an example user interface 400 that depicts a presented visual representation layer of a category of member profile information, consistent with some embodiments.

The user interface 400 depicts a visual representation layer of a visual representation that is presented by the presentation module 330 associated with education experience information attributes to a member of a social network. For example, the visual timeline 210 displays and highlights graphical elements of an education experience layer 410, such as a graphical element 412 associated with finishing university and a graphical element 414 associated with obtaining an MBA degree.

Additionally, the visual representation layer may also include visual detail windows 220 that present graphical elements representing details or other complementary information associated with the education experience layer 410. For example, the visual representation layer may present within detail window 220 text-based content 222 that provides details about various education achievements associated with the member of the social network and visual-based content 224 that presents images, video clips, pictures, and so on, associated with the various education experiences, among other things. Thus, the visual representation layer include a visual timeline 210 that highlights graphical elements of the visual representation layer (e.g., graphical elements 412, 414 of education experience layer 410) as well as a visual detail window 220 that presents information associated with one or more education experiences associated with the visual representation layer.

In some example embodiments, the user interface 400 may provide user-selectable buttons 430 or elements that enable a user to select a visual representation layer to be rendered by the rendering module 320 and presented by the presentation module 330 via the user interface 400. For example FIG. 4 shows that an “Education” button 432 has been selected, causing the user interface to present and/or highlight a visual representation layer associated with a member's education experiences. In response to a selection of other buttons (e.g. “work” or “social”) the user interface may present other representation layers associated with the selected buttons.

The presentation module 330 may present a visual representation and/or graphical element, within or proximate to various pages presented by the social network service 130. For example, the presentation module 330, in some example embodiments, may present a thumbnail view of a rendered visual representation proximate to member profile information presented by a profile page associated with the member of the social network, which may enable other members to find and view the visual representation, among other benefits.

Furthermore, the presentation module 330 may provide graphical elements that enable viewers of a visual representation to interact with the visual representation. For example, the presentation engine 330 may facilitate such interaction by presenting a comment field that is configured to receive comments from members of the social network that view a presented visual representation, and present the comments along with the visual representation.

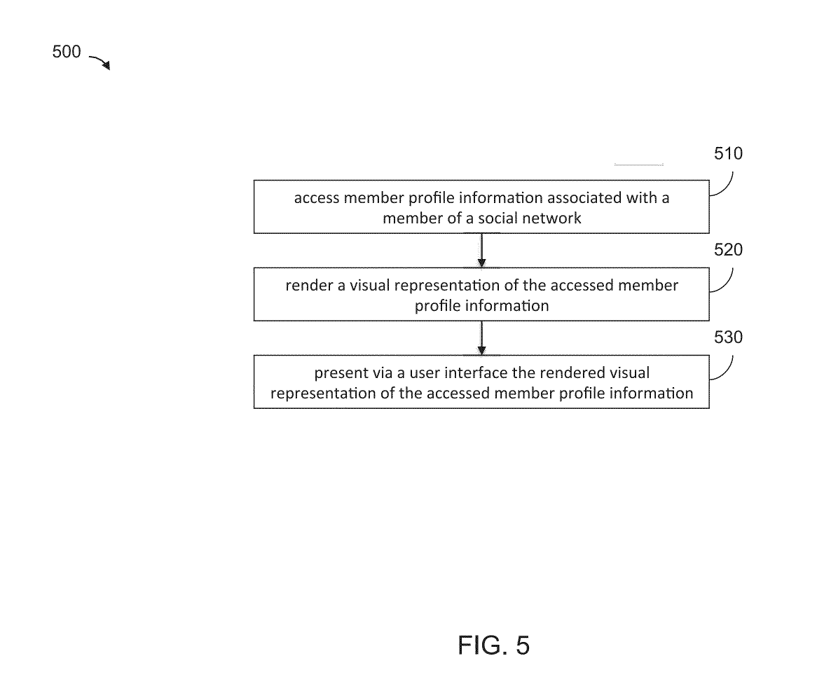

In some example embodiments, some or all of the engines, modules, and/or other components described herein may perform methods for rendering and/or presenting visual representations associated with information contained, accessed, and/or provided by a social network. FIG. 5 is a flow diagram illustrating an example method 500 for presenting a visual representation of social network information, consistent with some embodiments.

In operation 510, the visual representation engine 150 accesses member profile information associated with a member of a social network. For example, the profile access module 310 accesses member profile via one or more Application Programming Interfaces (APIs) associated with the social network service 130, the member database 132, and/or the social graph database 134.

In operation 520, the visual representation engine 150 renders a visual representation of the accessed member profile information, such as a visual representation that includes a first visual representation layer associated with a first category of the member profile information and a second visual representation layer associated with a second category of the member profile information. For example, the rendering module 320 generates one or more visual representation layers that include graphical elements associated with member profile information, and renders a visual representation that includes the one or more visual representation layers.

In operation 530, the visual representation engine 150 presents, via a user interface, the rendered visual representation of the accessed member profile information. For example, the presentation module 330 causes the user interface 400 to present a single-layered or multi-layered visual representation of member profile information that includes a visual timeline 410 and detail windows 420, among other elements.

In some example embodiments, the visual rendering engine 150 may present a visual representation for a member along with other visual representations for other members, such as target members. Referring back to FIG. 3, the target module 340 is configured and/or programmed to access information associated with an aspiration target and/or target member of the social network, and provide the information to the rendering module 320, which may render a visual representation that includes multiple visual timelines, among other things.

For example, the target module 340 may access information associated with a generic member having certain attributes, such as a generic member having attributes associated with being a CEO of a company. As another example, the target module 340 may receive a selection from a member of another member, or target member, of the social network, and access information associated with the selected target member of the social network.

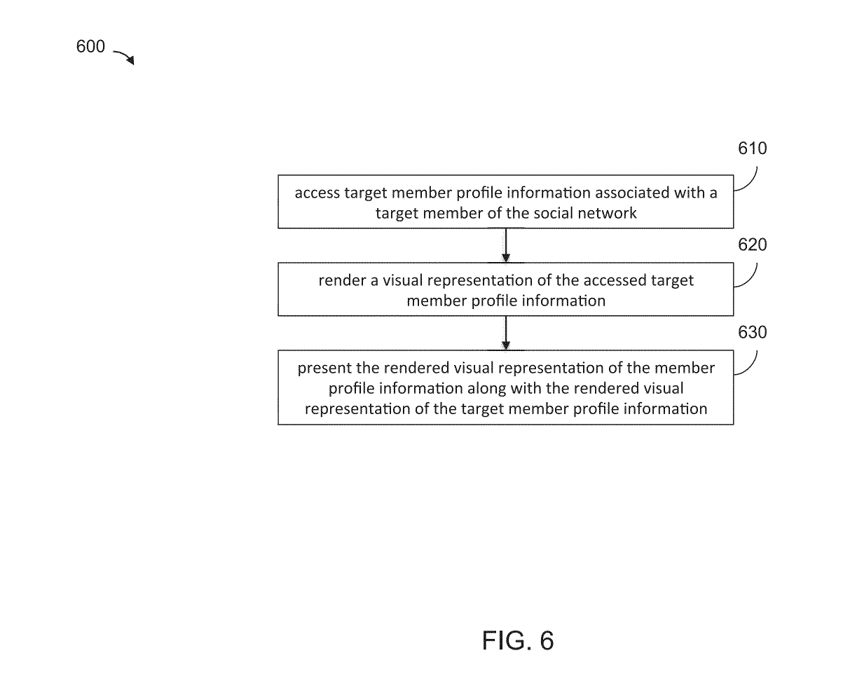

In some example embodiments, some or all of the engines, modules, and/or other components described herein may perform methods for rendering and/or presenting a visual representation along with a target visual representation. FIG. 6 is a flow diagram illustrating an example method 600 for presenting multiple visual representations of social network information, consistent with some embodiments.

In operation 610, the visual representation engine 150 accesses target member profile information associated with a target member of the social network. For example, the target module 340 accesses information associated with a specific member of the social network (e.g., another actual member having certain attributes or experiences), and/or information associated with a generic member of the social network (e.g., a generated member that represents a member having certain attributes or experiences).

In operation 620, the visual representation engine 150 renders a visual representation of the accessed target member profile information. For example, the rendering module 220 renders a visual representation associated with the target member.

In operation 630, the visual representation engine 150 present, via a user interface, the rendered visual representation of the accessed member profile information along with the rendered visual representation of the accessed target member profile information. For example, the presentation module 330 causes the user interface 400 to present a visual representation of a member along with a visual representation of a target member.

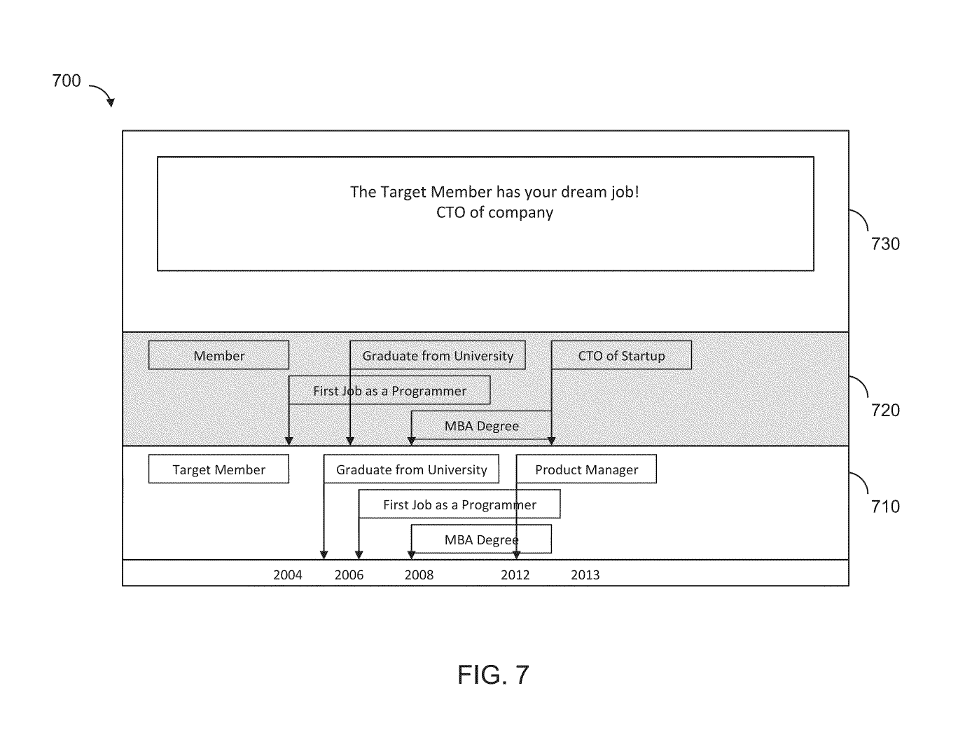

For example, FIG. 7 depicts an example user interface 700 that presents multiple visual representations of social network information, consistent with some embodiments. The user interface 700 includes a visual timeline 710 associated with a target member proximate to a visual timeline associated with a member viewing the user interface, such as a member that selected the target member in order to view a comparison of the member's visual representation to the target members visual representation. The user interface may also include a detail window 730 that provides information about the member, the target member, and/or information comparing the two members (e.g., the text 735 indicating “the target member “has your dream job!”).

Thus, in some example embodiments, the visual rendering engine 150 may enable a member of a social network to compare themselves to other members (or, to generic representations of people), by rendering and presenting multiple visual representations for target members proximate to a visual representation associated with the member, among other benefits.

In some example embodiments, the visual representation engine 150 and/or the social network service 130 may control access privileges associated with what viewers are authorized to view some or all of another member's visual representation. For example, the visual representation engine 150 may restrict viewership of some or all aspects of a member's visual representation to other members of the social network that are connected to the member within the social network, and may present portions of the rendered visual representation based on the determining that a member is associated with access credentials for the presented portions.

That is, the visual rendering engine 150 may identify relationships and/or connections between members based on social graph information, and determine access credentials based on the social graph information. For example, the visual representation engine 150 may determine that other members connected to a member are permitted to view the member's visual representation, may determine that other members sharing at least one attribute in common (e.g. went to same school, work in same field, and so on) are permitted to view the visual representation layers associated with the shared attribute, and so on.

Of course, in some example embodiments, the visual representation engine 150 may enable a member to select or otherwise determine the authorization settings for viewership of his/her own visual representation.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

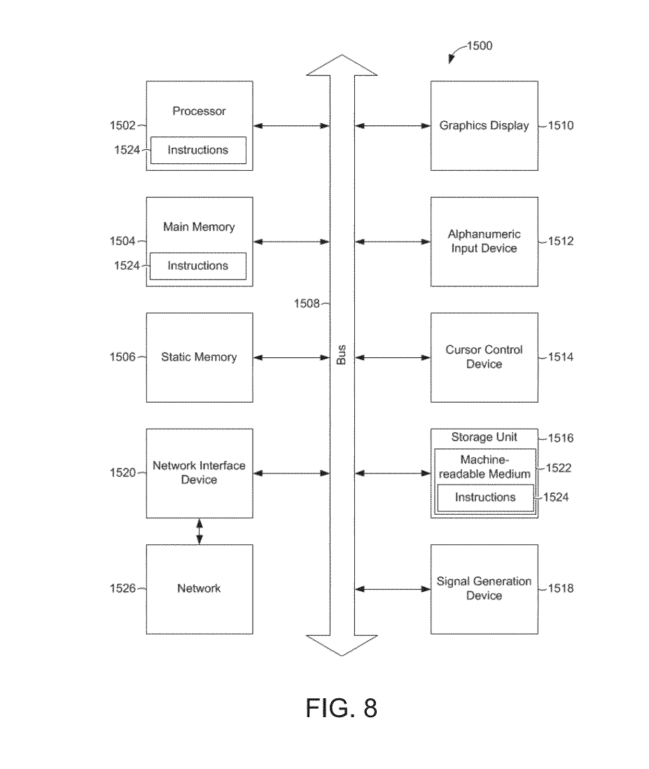

FIG. 8 is a block diagram 1500 of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
accessing member profile information associated with a member of a social network;
rendering a visual representation of the accessed member profile information that includes a first visual representation layer associated with a first category of the member profile information and a second visual representation layer associated with a second category of the member profile information; and
presenting via a user interface the rendered visual representation of the accessed member profile information.

2. The method of claim 1, wherein rendering a visual representation of the accessed member profile information includes rendering a visual representation that includes at least one element from the first visual representation layer and at least one element from the second visual representation layer.

3. The method of claim 1, further comprising:
receiving via the user interface a selection of the first category of the member profile information;
wherein presenting via a user interface the rendered visual representation of the accessed member profile information includes presenting the first visual representation layer based on the received selection.

4. The method of claim 1, further comprising:
accessing generic member profile information associated with a generic member of the social network;
rendering a visual representation of the accessed generic member profile information; and
presenting via the user interface the rendered visual representation of the accessed member profile information along with the rendered visual representation of the accessed generic member profile information.

5. The method of claim 1, further comprising:
accessing target member profile information associated with a target member of the social network;
rendering a visual representation of the accessed target member profile information; and
presenting via the user interface the rendered visual representation of the accessed member profile information along with the rendered visual representation of the accessed target member profile information.

6. The method of claim 1, further comprising:
receiving a selection of a target member within the social network;
accessing target member profile information associated with the selected target member of the social network;
rendering a visual representation of the accessed target member profile information; and
presenting via the user interface the rendered visual representation of the accessed member profile information along with the rendered visual representation of the accessed target member profile information.

7. The method of claim 1, wherein presenting via a user interface the rendered visual representation of the accessed member profile information includes presenting the visual representation of the accessed member profile information to other members of the social network that are connected to the member within the social network.

8. The method of claim 1, further comprising:
determining access credentials associated with another member of the social network; and
presenting via the user interface at least a portion of the rendered visual representation based on the determined access credentials.

9. The method of claim 1, further comprising:
providing, via the user interface, a comment field that is configured to receive comments from members of the social network that view the presented visual representation;
presenting information associated with the received comments along with the presented visual representation.

10. The method of claim 1, wherein the first category of the member profile information is a category associated with work experience of the member and the second category of the member profile information is a category associated with educational experience of the member.

11. The method of claim 1, wherein presenting via a user interface the rendered visual representation of the accessed member profile information includes presenting a thumbnail view of the rendered visual representation proximate to member profile information presented by a profile page associated with the member of the social network.

12. The method of claim 1, wherein rendering a visual representation of the accessed member profile information includes automatically rendering the visual representation of the accessed member profile information.

13. The method of claim 1, further comprising:
receiving information associated with at least a portion of the accessed member profile information from the member of the social network;
wherein rendering a visual representation of the accessed member profile information includes modifying the visual representation based at least in part of the received information associated with at least a portion of the accessed member profile information.

14. A system, comprising:
a profile access module that is configured to access member profile information associated with a member of a social network;
a rendering module that is configured to render a visual representation of the accessed member profile information with a representation layer associated with work experience attributes of the member; and
a presentation module that is configured to present via a user interface the rendered visual representation of the accessed member profile information.

15. The system of claim 14, wherein the rendering module is configured to render the visual representation of the accessed member profile information with a representation layer associated with educational experience attributes of the member.

16. The system of claim 14, wherein the rendering module is configured to render the visual representation of the accessed member profile information with a representation layer associated with skill attributes of the member.

17. The system of claim 14, further comprising:
a target module that is configured to access information associated with a aspiration target;
wherein the rendering module is configured to render a visual representation of the accessed information associated with the aspiration target; and
wherein the presentation module is configured to present via the user interface the rendered visual representation of the accessed member profile information along with the rendered visual representation of the accessed target information associated with the aspiration target.

18. The system of claim 14, further comprising:
a target module that is configured to access information associated with a target member of the social network;
wherein the rendering module is configured to render a visual representation of the accessed information associated with the target member; and
wherein the presentation module is configured to present via the user interface the rendered visual representation of the accessed member profile information along with the rendered visual representation of the accessed target information associated with the target member

19. A computer-readable storage medium whose contents, when executed by a computing system, cause the computing system to perform operations, comprising:
accessing member profile information associated with a member of a social network;
rendering a visual representation of the accessed member profile information that includes a first visual representation layer associated with a first category of the member profile information and a second visual representation layer associated with a second category of the member profile information; and
presenting via a user interface the rendered visual representation of the accessed member profile information.

20. The computer-readable storage medium of claim 19, further comprising:
determining access privileges for a viewer of the presented visual representation;
wherein presenting via a user interface the rendered visual representation includes presenting a portion of the rendered visual representation based on the determined access privileges.
